(19) United States
(12) Patent Application Publication
(10) Pub. No.: US 2013/0286328 A1
(43) Pub. Date: Oct. 31, 2013

(54) LIQUID-CRYSTAL DISPLAY

(71) Applicant: INNOLUX CORPORATION, Chu-Nan (TW)

(72) Inventors: Chih-Yung HSIEH, Chu-Nan (TW); Ying-Jen CHEN, Chu-Nan (TW); Yi-Hsin CHEN, Chu-Nan (TW); Yi-Da HUANG, Chu-Nan (TW); Wei-Jean LIU, Chu-Nan (TW)

(73) Assignee: INNOLUX CORPORATION, Chu-Nan (TW)

(21) Appl. No.: 13/794,556

(22) Filed: Mar. 11, 2013

(30) Foreign Application Priority Data
Apr. 25, 2012 (TW) 101114644

(51) Int. Cl. G02F 1/137

(52) U.S. Cl. CPC G02F 1/137
USPC 349/85

(57) ABSTRACT

An embodiment of a liquid-crystal display is provided which includes: a first substrate having a first pixel electrode, a second pixel electrode, and a third pixel electrode; a second substrate having an opposite electrode, wherein the first pixel electrode, the second pixel electrode and the third pixel electrode, respectively, have a first overlapping area, a second overlapping area and a third overlapping area overlapped with the opposite electrode, and wherein the first overlapping area is smaller than the second overlapping area and the third overlapping area; and a liquid-crystal layer interposed between the first substrate and the second substrate. In addition, another embodiment of a liquid-crystal display is also provided, in which the first pixel electrode, the second pixel electrode and the third pixel electrode have different gaps with the opposite electrode, respectively.

### CROSS REFERENCE TO RELATED APPLICATIONS

This application claims priority of Taiwan Patent Application No. 101114644, filed on Apr. 25, 2012, the entirety of which is incorporated by reference herein.

### FIELD OF THE INVENTION

The present disclosure relates to a liquid-crystal display. More particularly, the present disclosure relates to a liquid-crystal display which may improve grey level inversion.

### DESCRIPTION OF THE RELATED ART

A liquid-crystal display is an imaging device that displays images by controlling light flux because light has different polarization and refraction performances with respect to the arrangements of liquid-crystal molecules. A conventional twisted nematic (TN) liquid-crystal display has good transmittance performance, but it can only have a narrow viewing angle due to the structure and optical properties of the TN type liquid crystal. Thus, to develop a liquid-crystal display which has good transmittance and a wide viewing angle represents breakthrough progress.

A vertical alignment (VA) type wide-viewing-angle LCD has been developed to solve the aforementioned problems. The VA type LCD comprises a patterned vertical alignment (PVA) type LCD, a multi-domain vertical alignment (MVA) type LCD, and so on. The PVA type LCD achieves the goal of wide-viewing-angle characteristics by applying a fringing-field effect thereto and optical compensation films. The MVA type LCD widens the viewing-angle and improves transmittance of the liquid-crystal display by dividing a pixel area into multi domains and tilting liquid crystals in the multi domains in several different directions using protrusion features or specific patterns.

However, the current VA type LCD still has shortcomings that need to be addressed. Referring to FIG. 1, a top view of a liquid-crystal layer of a VA type LCD 100 according to the known art is illustrated. When a voltage is applied to the electrodes, liquid-crystal molecules 102 and 106 tilt respectively in horizontal directions 120, 130, and the liquid-crystal molecules 102 and 104 which are arranged in a direction parallel to an electric field (such as parallel to the normal line of the paper) tilt in the same horizontal direction, such as the horizontal direction 120, without a horizontal twist. Light cannot penetrate through the liquid-crystal molecules 102 and 104 since they are tilted in the same horizontal direction, and therefore the transmittance of the VA type LCD is reduced. In theory, the LCD has 255 grey levels, and higher grey levels should bring higher brightness. However, it is observed that higher grey levels bring lower brightness than lower grey levels when providing a large viewing angle. The black-white inversion phenomenon is called grey level inversion.

A technique which adds a chiral dopant to the liquid-crystal layer was developed to solve the aforementioned problems. For example, referring to FIG. 2, a top view of a liquid-crystal layer of a VA type LCD that includes the chiral dopant is illustrated. When a voltage is applied to the electrodes, the liquid-crystal molecules 202 and 206 respectively tilt in horizontal directions 220 and 230, and the liquid-crystal molecules 202 and 204 which are arranged in a direction parallel to the electric field (such as the direction through the paper) also have different horizontal twists. Accordingly, light can penetrate through the liquid-crystal layer by the birefringence of the liquid-crystal molecules 202 and 204. In addition, optical dark fringes resulting from the liquid-crystal molecules which are not tilted or tilted in undesired directions can also be narrowed and faded, and therefore the grey level inversion is improved.

Although the grey level inversion can be improved by doping the chiral dopant to the liquid-crystal layer, the grey level inversion still remains, and it is particularly serious in the blue pixel and/or with an increased gap between the substrate (i.e. the thickness of the liquid-crystal layer). Accordingly, a new technique for improving the transmittance preventing the grey level inversion in the LCD is needed.

### BRIEF SUMMARY OF THE INVENTION

One object of the present disclosure is to provide a liquid-crystal display, including: a first substrate having a first pixel electrode, a second pixel electrode and a third pixel electrode; a second substrate having an opposite electrode, wherein the first pixel electrode has a first overlapping area overlapped with the opposite electrode, the second pixel electrode has a second overlapping area overlapped with the opposite electrode, and the third pixel electrode has a third overlapping area overlapped with the opposite electrode; and a liquid-crystal layer interposed between the first substrate and the second substrate; wherein the first overlapping area is smaller than the second overlapping area, and the first overlapping area is smaller than the third overlapping area.

Another object of the present disclosure is to provide a vertical alignment liquid-crystal, including: a first substrate having a first pixel electrode, a second pixel electrode and a third pixel electrode; a second substrate having an opposite electrode; and a liquid-crystal layer interposed between the first substrate and the second substrate, wherein the liquid-crystal layer comprises a chiral dopant doped therein; wherein the gap between the first pixel electrode and the second substrate is smaller than the gap between the second pixel electrode and the second substrate, and the gap between the first pixel electrode and the second substrate is smaller than the gap between the third pixel electrode and the second substrate.

### BRIEF DESCRIPTION OF THE DRAWINGS

The invention will now be described, by way of example, with reference to the accompanying drawings, in which:

FIG. 1 shows a top view of a liquid-crystal layer of an LCD according to known art.

FIG. 2 shows a top view of a liquid-crystal layer of a VA type LCD according to known art.

FIG. 3 shows a cross-sectional view of an LCD according to an embodiment of the present disclosure.

FIGS. 4-8 show top views of LCDs according to some embodiments of the present disclosure.

FIG. 9 shows a cross-sectional view of an LCD according to another embodiment of the present disclosure.

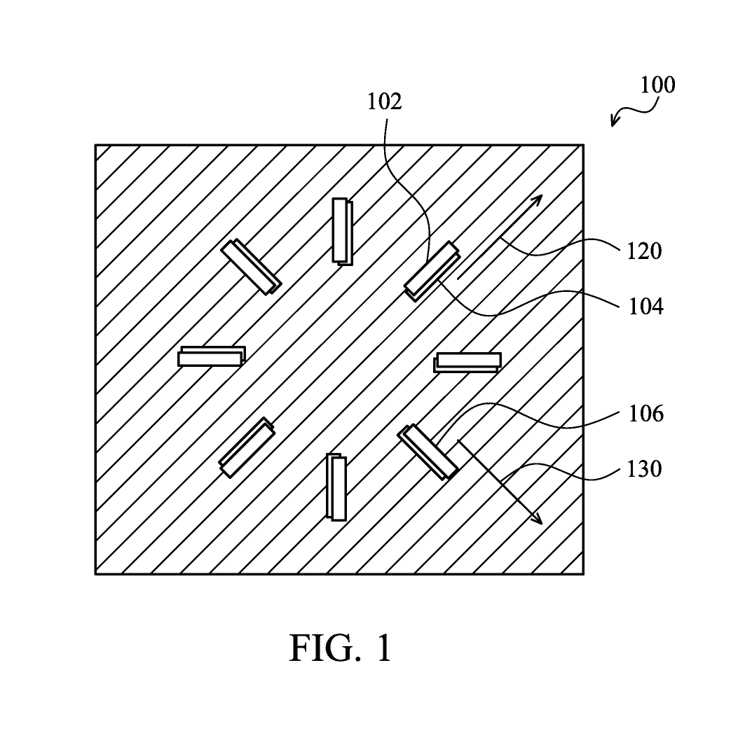

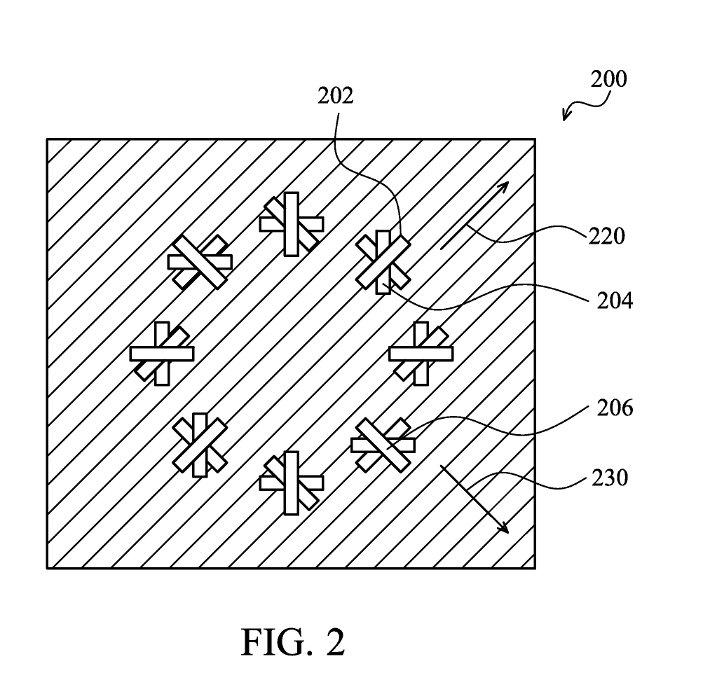

### DETAILED DESCRIPTION OF THE INVENTION

The following description is of the best-contemplated mode of carrying out the invention. This description is made for the purpose of illustrating the general principles of the invention and should not be taken in a limiting sense. For example, the formation of a first feature over, above, below, or on a second feature in the description that follows may include embodiments in which the first and second features are formed in direct contact, and may also include embodiments in which additional features may be formed between the first and second features, such that the first and second features may not be in direct contact. The scope of the invention is best determined by reference to the appended claims.

It should be understood that although the terms first, second, third, etc., may be used herein to describe various elements, components, regions, layers, and/or sections, these elements, components, regions, layers, and/or sections should not be limited by these terms. These terms are only used to distinguish one element, component, region, layer, and/or section from another element, component, region, layer, and/or section. For example, a first element, component, region, layer, and/or section could be termed a second element, component, region, layer, and/or section without departing from the teachings of the example embodiments.

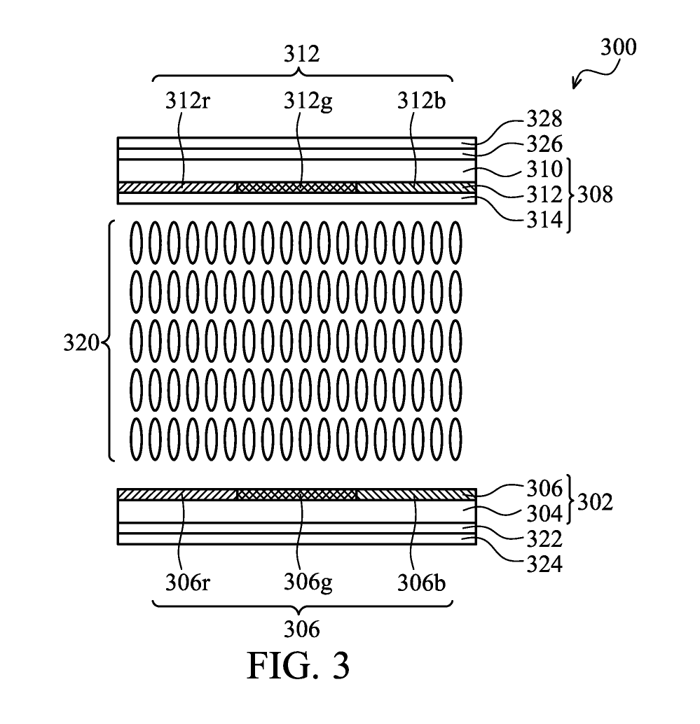

FIG. 3 shows a cross-sectional view of a liquid-crystal display (LCD) 300 according to an embodiment of the present disclosure. The LCD 300 may be a vertical alignment (VA) type LCD. As shown in FIG. 3, the LCD 300 may comprise a first substrate 302 and a second substrate 308 opposite and parallel to each other. In an embodiment, the first substrate 302 may be a thin-film transistor (TFT) substrate including a base substrate 304 with at least one first pixel unit 306b, at least one second pixel unit 306g, and at least one third pixel unit 306r disposed thereon. In some embodiments, the first pixel unit 306b, the second pixel unit 306g, and the third pixel unit 306r may be a blue pixel unit 306b, a green pixel unit 306g, and a red pixel unit 306r, respectively. Each of the pixel units may comprise a pixel electrode 306 and a TFT (not shown) disposed on the base substrate 304. For example, the first pixel unit 306b, the second pixel unit 306g, and the third pixel unit 306r may respectively comprise the first pixel electrode 306b, the second pixel electrode 306g, and the third pixel electrode 306r. A black matrix (not shown) may be disposed between each pixel. In the following sections of the present disclosure, for clarity and understanding, the pixel electrode in the first electrode unit 306b is referred as to the blue pixel electrode 306b, the pixel electrode in the second pixel 306g unit is referred as to the green pixel electrode 306g, and the pixel electrode in the third pixel unit 306r is referred as to the red pixel electrode 306r. However, it is not intended to limit the scope of these pixel electrodes.

The second substrate 308 may comprise a glass substrate with a color filter 312 and an opposite electrode 314 disposed thereon. The color filter 312 may comprise a blue filter 312b with respect to the blue pixel electrode 306b, a green filter 312g with respect to the green pixel electrode 306g and a red filter 312r with respect to the red pixel electrode 306r. In an embodiment, the blue filter 312b, the green filter 312g, and the red filter 312r may have the same thickness.

A liquid-crystal layer 320 may be interposed between the first substrate 302 and the second substrate 308, such as between the pixel electrode 306 and the opposite electrode 314. The liquid-crystal layer 320 may comprise a twisted nematic liquid-crystal material, for example a negative nematic liquid-crystal or a positive nematic liquid crystal. In an embodiment, chiral active substances, such as chiral dopants, are added in the liquid-crystal layer 320. Thus, the liquid-crystal molecules of the liquid-crystal layer 320 may twist along an axis, thereby having optical activity, and the axis is parallel to a normal line of the first substrate 302. In an optional embodiment, the LCD 300 may further comprise a first compensation film 322 and the first polarizer 324 disposed on the first substrate 302, and may further comprise a second compensation film 326 and a second polarizer 328 disposed on the second substrate 308.

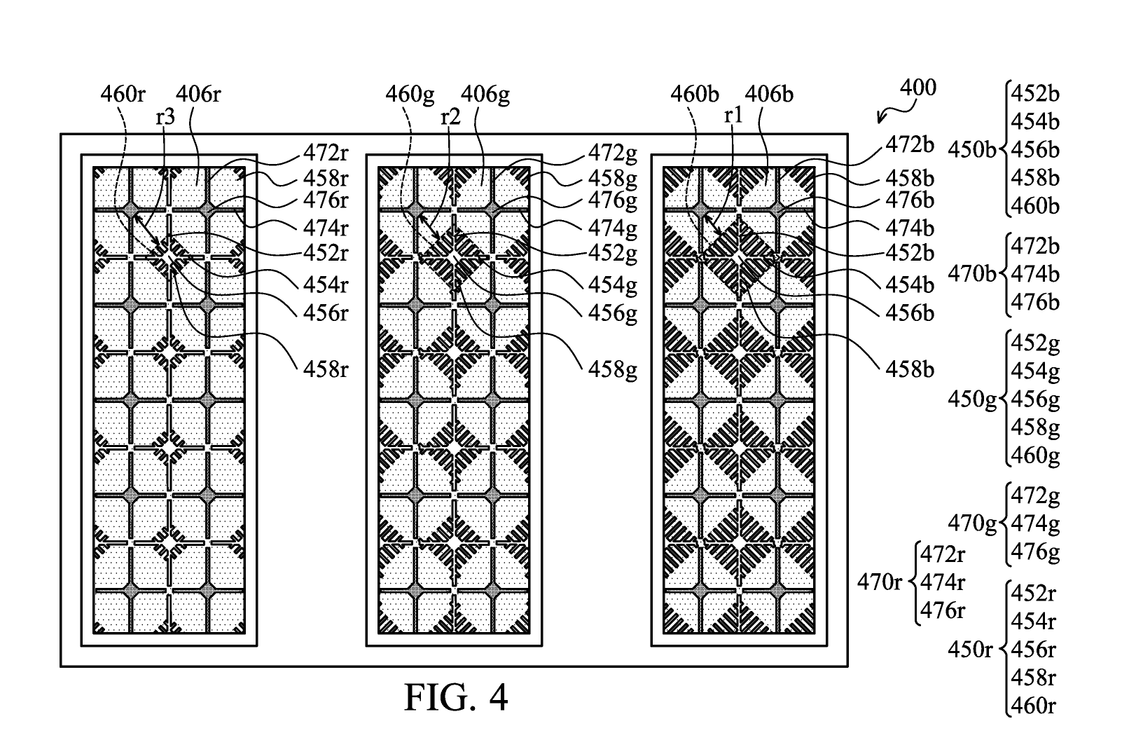

FIG. 4 shows a top view of an electrode pattern of an LCD 400 according to an embodiment of the present disclosure. In FIG. 4, a unit pattern of the pixel electrodes 406b, 406g, 406r on the first substrate 302 and the opposite electrode 314 on the second substrate 308 is illustrated. The cross-sectional view of the LCD 400 may be referred to in FIG. 3.

Referring to FIG. 4, the blue pixel electrode 406b may comprise a first hollow portion 450b; the green pixel electrode 406g may comprise a green hollow portion 450g; and the red pixel electrode 406r may comprise a red hollow portion 450r. The opposite electrode 314 may comprise a fourth hollow portion 470b with respect to the blue pixel electrode 406b, a fifth hollow portion 470g with respect to the green pixel electrode 406g, and a sixth hollow portion 470r with respect to the red pixel electrode 406r. The blue pixel electrode 406b and the opposite electrode 314 may have a first overlapping area. In other words, the first overlapping area is an overlapping area of the area of the blue pixel electrode 406b with the removal of the area of the first hollow portion 450b and the area of the opposite electrode 314 over the blue pixel electrode 406b with the removal of the fourth hollow portion 470b. Similarly, the green pixel electrode 406g and the opposite electrode 314 may have a second overlapping area. The second overlapping area is an overlapping area of the area of the green pixel electrode 406g with the removal of the area of the first hollow portion 450g and the area of the opposite electrode 314 over the green pixel electrode 406g with the removal of the fifth hollow portion 470g. The red pixel electrode 406r and the opposite electrode 314 may have a third overlapping area. The third overlapping area is an overlapping area of the area of the red pixel electrode 406r with the removal of the area of the first hollow portion 450r and the area of the opposite electrode 314 over the red pixel electrode 406r with the removal of the sixth hollow portion 470r.

The first hollow portion 450b may comprise at least one first longitudinal slit area 452b, at least one first transverse slit area 454b and at least one first cross area 456b located at the intersection of the first longitudinal slit area 452b and the first transverse slit area 454b. The second hollow portion 450g may comprise at least one second longitudinal slit area 452g, at least one second transverse slit area 454g, and at least one second cross area 456g located at the intersection of the second longitudinal slit area 452g and the second transverse slit area 454g. The third hollow portion 450r may comprise at least one third longitudinal slit area 452r, at least one third transverse slit area 454r and at least one third cross area 456r located at the intersection of the third longitudinal slit area 452r and the third transverse slit area 454r. The fourth hollow portion 470b may comprise at least one fourth longitudinal slit area 472b, at least one fourth transverse slit area 474b, and at least one fourth cross area 476b located at the intersection of the fourth longitudinal slit area 472b and the fourth transverse slit area 474b. The fifth hollow portion 470g may comprise at least one fifth longitudinal slit area 472g, at least one fifth transverse slit area 474g, and at least one fifth cross area 476g located at the intersection of the fifth longitudinal slit area 472g and the fifth transverse slit area 474g. The sixth hollow portion 470r may comprise at least one sixth longitudinal slit area 472r, at least one sixth transverse slit area 474r, and at least one sixth cross area 476r located at the intersection of the sixth longitudinal slit area 472r and the sixth transverse slit area 474r. The first to sixth longitudinal slit areas 452b, 452g, 452r, 472b, 472g, 472r may be substantially perpendicular to the first to sixth transverse slit areas 454b, 454g, 454r, 474b, 474g, 474r. The first to sixth cross areas 456b, 456g, 456r, 476b, 476g, 476r may have various suitable shapes, such as a circle, rectangle or rhombus.

The first longitudinal slit area 452b, the first transverse slit area 454b, and the first cross area 456b, respectively, may be interleavely arranged with the fourth longitudinal slit area 472b, the fourth transverse slit area 474b and the fourth cross area 476b. The second longitudinal slit area 452g, the second transverse slit area 454g and the second cross area 456g, respectively, may be interleavely arranged with the fifth longitudinal slit area 472g, the fifth transverse slit area 474g and the fifth cross area 476g. The third longitudinal slit area 452r, the third transverse slit area 454r and the third cross area 456r, respectively, may be interleavely arranged with the sixth longitudinal slit area 472r, the sixth transverse slit area 474r and the sixth cross area 476r.

In an embodiment, each of the first to sixth cross areas 456b, 456g, 456r, 476b, 476g, 476r may have an area substantially greater than the overlapping area of one intersection of these longitudinal and transverse slit areas. In some embodiments, the fourth to sixth longitudinal slit areas 472b, 472g, 472r may respectively extend over the fourth to sixth cross areas 476b, 476g, 476r. Similarly, the fourth to sixth transverse slit areas 474b, 474g, 474r may respectively extend over the fourth to sixth cross areas 476b, 476g, 476r.

The first hollow portion 450b may further comprise at least one first finger-type extension area 458b. The first finger-type extension area 458b may comprise a plurality of separated finger-type electrodes extending around from the first longitudinal slit area 452b, the first transverse slit area 454b and the first cross section 456b, such that the first hollow portion 450b may comprise at least one first rhombus hollow portion 460b (shown as the dotted line) having a substantially rhombus shape with a center located at the first cross area 456b. The second hollow portion 450g may further comprise at least one second finger-type extension area 458g. The second finger-type extension area 458g may comprise a plurality of separated finger-type electrodes extending around from the second longitudinal slit area 452g, the second transverse slit area 454g and the second cross section 456g, such that the second hollow portion 450g may comprise at least one second rhombus hollow portion 460g (shown as the dotted line) which has a substantially rhombus shape with a center located at the second cross area 456g. The third hollow portion 450r may further comprise at least one third finger-type extension area 458r. The third finger-type extension area 458r may comprise a plurality of separated finger-type electrodes extending around from the third longitudinal slit area 452r, the third transverse slit area 454r, and the third cross section 456r, such that the third hollow portion 450r may comprise at least one third rhombus hollow portion 460r (shown as the dotted line) which has a substantially rhombus shape with a center located at the third cross area 456r.

In an embodiment, the pixel electrodes 406b, 406g, 406r may generate a fringing electric field due to the presence of the first to sixth hollow portions 450b, 450g, 450r, 470b, 470g, 470r (including the first to third rhombus hollow portions 460b, 460g 460r), and thus the pixel electrodes 406b, 406g, 406r and the opposite electrode 314 may control the liquid-crystal layer 320 more precisely.

Referring to FIG. 4 again, a distance from a side of the first rhombus hollow portion 460b to its adjacent fourth cross section area 456b is defined as the first distance r1. A distance from a side of the second rhombus hollow portion 460g to its adjacent fifth cross section area 456g is defined as the second distance r2. A distance from a side of the third rhombus hollow portion 460r to its adjacent sixth cross section area 456r is defined as the third distance r3. The first distance r1 may be less than the second distance r2 and the third distance r3. This is because the first rhombus hollow portion 460b has an area greater than that of the second and third rhombus hollow portions 460g, 460r.

In this embodiment, by defining the first distance r1 as being less than the second distance r2 and the third distance r3, the first overlapping area of the blue pixel electrode 406b and the opposite electrode 314 may be smaller than the second overlapping area and the third overlapping area. The grey level inversion in the blue pixel unit 406b can therefore be improved. In addition, since the grey level inversion in the green and red pixel units 406g, 406r is relatively minor compared to that in the blue pixel unit 406b, the green and red pixel electrodes 406g, 406r may have a relatively greater overlapping area with the opposite electrode 314 so as to achieve a better transmittance. In addition, although FIG. 4 only shows that the second overlapping area of the green pixel electrode 406b and opposite electrode 314 is smaller than the third overlapping area of the red pixel electrode 406r and opposite electrode 314, in other embodiments, the second overlapping area can be substantially equal to the third overlapping area (i.e., the second distance r2 being substantially equal to the third distance r3) for achieving much better transmittance.

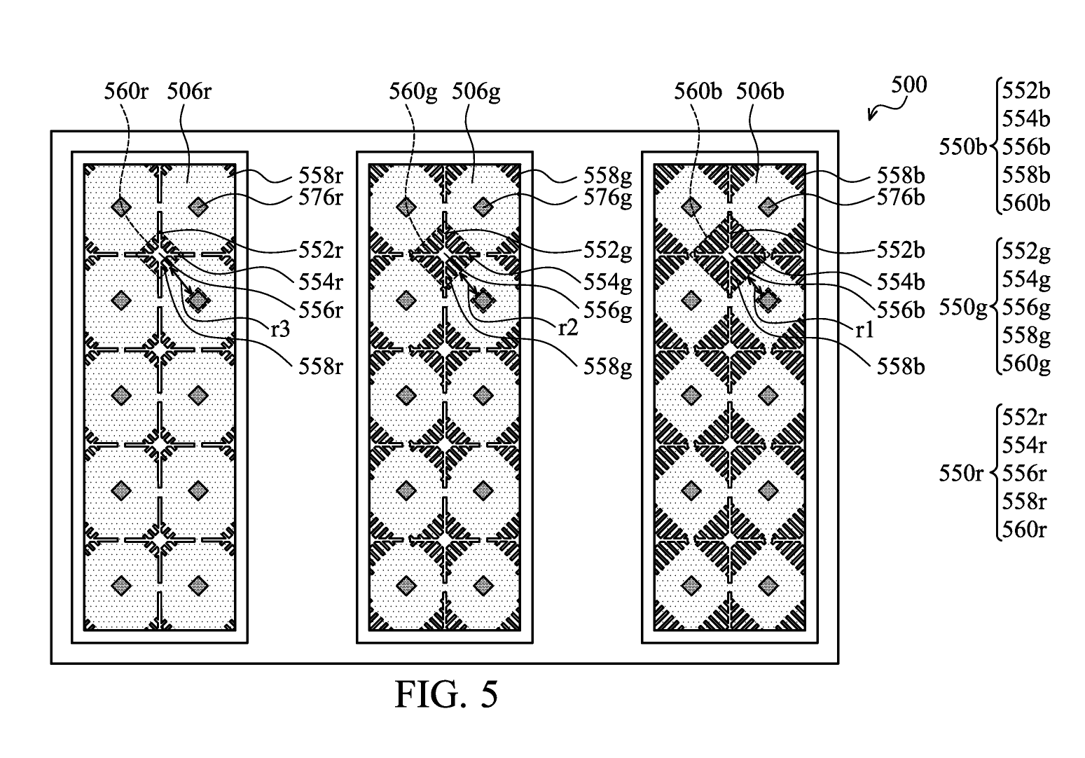

FIG. 5 shows a top view of an electrode pattern of an LCD 500 according to an embodiment of the present disclosure. In FIG. 5, a unit pattern of the pixel electrodes 506b, 506g, 506r on the first substrate 302 and the opposite electrode 314 on the second substrate 308 is illustrated. The cross-sectional view of the LCD 500 may be referred to in FIG. 3. In this embodiment, like reference numerals are used to indicate elements substantially similar to the elements described in the above embodiments.

This embodiment is similar to the embodiment shown in FIG. 4. For example, the first rhombus hollow portion 560b of the blue pixel electrode 506b may have a greater area than that of the second rhombus hollow portion 560g of the green pixel electrode 506g and the third rhombus hollow portion 560r of the red pixel electrode 506r (i.e., the first distance r1 is less than the second distance r2 and the third distance r3). However, it should be noted that, in this embodiment, the fourth to sixth hollow portions 560b, 560g, 560r on the opposite electrode 314 does not have the fourth to sixth longitudinal slit areas and the fourth to sixth transverse slit areas as shown in FIG. 4. Thus, in this embodiment, the fourth to sixth hollow portions are the fourth to sixth cross areas 576b, 576g, 576r. In addition, although FIG. 5 only shows that the fourth to sixth cross areas 576b, 576g, 576r have a rhombus shape, other shapes such as rectangles, circles or ovals can be used. In this embodiment, the fourth to sixth cross areas 576b, 576g, 576r may have the same size and area so as to have a first overlapping area smaller than the second overlapping area and the third overlapping area.

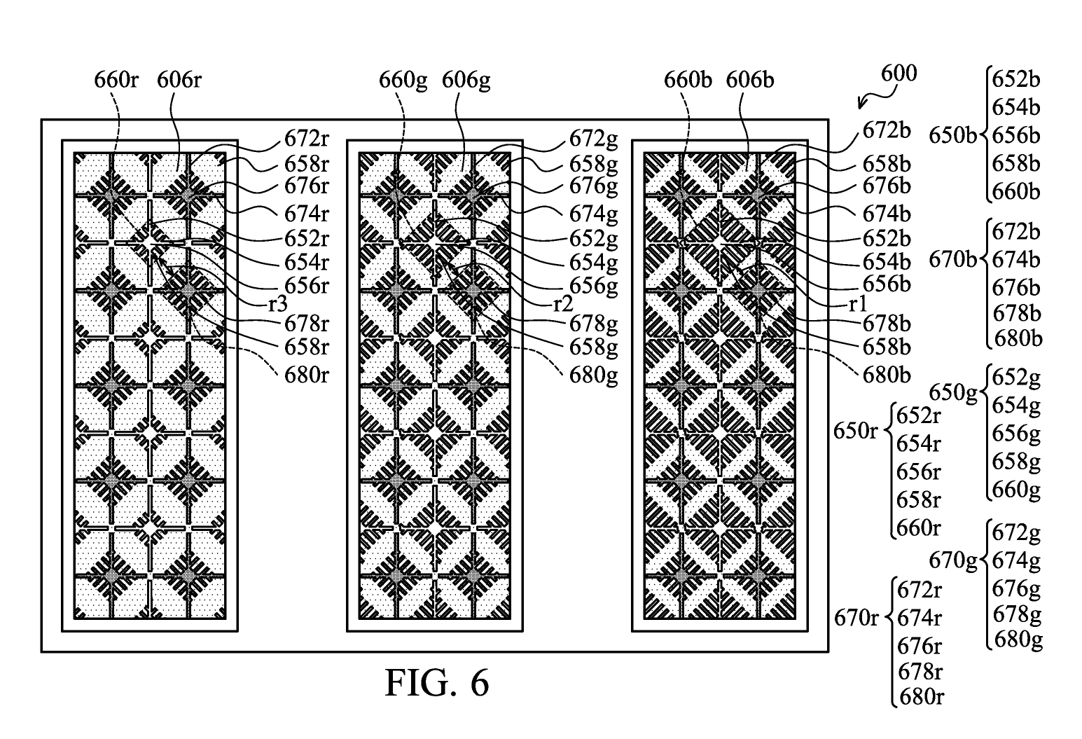

FIG. 6 shows a top view of an electrode pattern of an LCD 600 according to an embodiment of the present disclosure. A unit pattern of the pixel electrodes 606b, 606g, 606r on the first substrate 302 and the opposite electrode 314 on the second substrate 308 is illustrated in FIG. 6. The cross-sectional view of the LCD 600 may be referred to in FIG. 3. In this embodiment, like reference numerals are used to indicate elements substantially similar to the elements described in the above embodiments.

This embodiment is similar to the embodiment shown in FIG. 4. For example, the first rhombus hollow portion 660b of the blue pixel electrode 606b may have a greater area than that of the second rhombus hollow portion 660g of the green pixel electrode 606g and the third rhombus hollow portion 660r of the red pixel electrode 606r. However, it should be noted that, in this embodiment, the fourth hollow portion 670b may further comprise at least one fourth finger-type extension area 678b. The fourth finger-type extension area 678b may comprise a plurality of separated finger-type electrodes extending around from the fourth longitudinal slit area 672b, the fourth transverse slit area 674b, and the fourth cross section 676b, such that the fourth hollow portion 670b may comprise at least one fourth rhombus hollow portion 680b having a substantially rhombus shape with a center located at the fourth cross area 676b. The fifth hollow portion 670g may further comprise at least one fifth finger-type extension area 678g. The fifth finger-type extension area 678g may comprise a plurality of separated finger-type electrodes extending around from the fifth longitudinal slit area 672g, the fifth transverse slit area 674g, and the fifth cross section 676g, such that the fifth hollow portion 670g may comprise at least one fifth rhombus hollow portion 680g which has a substantially rhombus shape with a center located at the fifth cross area 676g. The sixth hollow portion 670r may further comprise at least one sixth finger-type extension area 678r. The sixth finger-type extension area 678r may comprise a plurality of separated finger-type electrodes extending around from the sixth longitudinal slit area 672r, the sixth transverse slit area 674r and the sixth cross section 676r, such that the sixth hollow portion 670r may comprise at least one sixth rhombus hollow portion 680r which has a substantially rhombus shape with a center located at the sixth cross area 676r.

In this embodiment, the distance from a side of the first rhombus hollow portion 660b to its adjacent fourth cross section area 656b is defined as the first distance r1. The distance from a side of the second rhombus hollow portion 660g to its adjacent fifth cross section area 656g is defined as the second distance r2. The distance from a side of the third rhombus hollow portion 660r to its adjacent sixth cross section area 656r is defined as the third distance r3. The first distance r1 may be less than the second distance r2 and the third distance r3. This is because the first rhombus hollow portion 670b has an area larger than that of the second and third rhombus hollow portions 680g, 680r. In an embodiment, the second rhombus hollow portions 680g may have an area less than that of the third rhombus hollow portions 680r for improving the grey level inversion in the green pixel unit 606g. Moreover, in other embodiments, the second rhombus hollow portions 680g may have an area substantially equal to that of the third rhombus hollow portions 680r if better transmittance is needed.

In this embodiment, the fourth to sixth longitudinal slit areas 672b, 672g, 672r may respectively extend over the fourth to sixth cross areas 676b, 676g, 676r. Similarly, the fourth to sixth transverse slit areas 674b, 674g, 674r may extend over the fourth to sixth cross areas 676b, 676g, 676r, respectively. In an optional embodiment, each of the fourth to sixth longitudinal and transverse slit areas 6742, 672g, 672r, 674b, 674g, 674r may be comprised in the fourth to sixth cross areas 676b, 676g, 676r and may not extend over them.

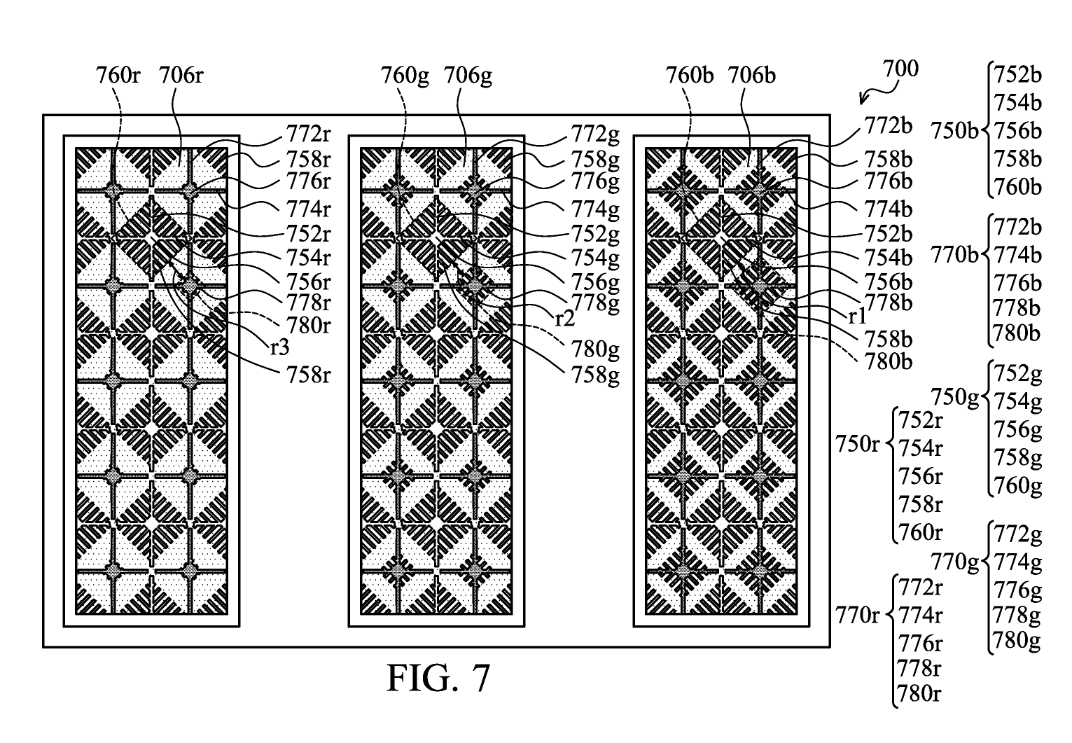

FIG. 7 shows a top view of an electrode pattern of an LCD 700 according to an embodiment of the present disclosure. In FIG. 6, a unit pattern of the pixel electrodes 706b, 706g, 706r on the first substrate 302 and the opposite electrode 314 on the second substrate 308 is illustrated. The cross-sectional view of the LCD 600 may be referred to in FIG. 3. In this embodiment, like reference numerals are used to indicate elements substantially similar to the elements described in the above embodiments.

This embodiment is similar to the embodiment shown in FIG. 6. However, in this embodiment, the first rhombus hollow portion 760b, the second rhombus hollow portion 760g, and the third rhombus hollow portion 760r may have the same size and shape, and the fourth rhombus hollow portion 780b may have an area greater than that of the second rhombus hollow portion 780b and the third rhombus hollow portion 780r. Thus, the first distance r1 may be less than the second distance r2 and the third distance r3. The first overlapping area of the blue pixel electrode 706b and the opposite electrode 314 may be smaller than that of the second overlapping area of the green pixel electrode 706g and the opposite electrode 314 and the third overlapping area of red pixel electrode 760r and the opposite electrode 314. In an embodiment, the fifth rhombus hollow portion 780g may have an area smaller than that of the sixth rhombus hollow portion for improving the grey level inversion in the green pixel unit 706g. In other embodiments, the fifth rhombus hollow portions 780g may have an area substantially equal to that of the sixth rhombus hollow portions 780r if better transmittance is needed.

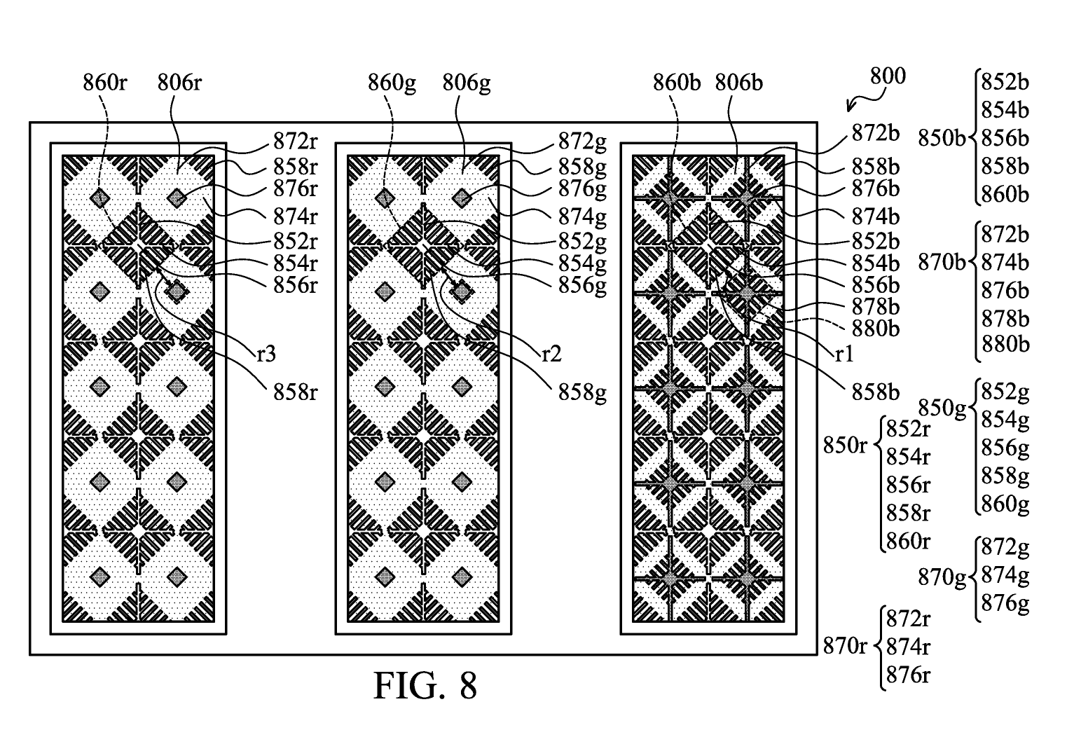

FIG. 8 shows a top view of an electrode pattern of an LCD 800 according to an embodiment of the present disclosure. In FIG. 8, a unit pattern of the pixel electrodes 806b, 806g, 806r on the first substrate 302 and the opposite electrode 314 on the second substrate 308 is illustrated. The cross-sectional view of the LCD 800 may be referred to in FIG. 3. In this embodiment, like reference numerals are used to indicate elements substantially similar to the elements described in the above embodiments.

This embodiment is similar to the embodiment shown in FIG. 7. However, in this embodiment, the fourth rhombus hollow portion 880b, the fifth rhombus hollow portion 880g and the sixth rhombus hollow portion 880r may have the same or different sizes and shapes. For example, referring to FIG. 8, the fifth hollow portion may comprise the fifth longitudinal slit area 872g, the fifth transverse slit area 874g, and the fifth cross area 876g. The sixth hollow portion may comprise the sixth longitudinal slit area 872r, the fifth transverse slit area 874 and the fifth cross area 876r. Compared to the fifth and six rhombus hollow portions 880g, 880r, the fourth rhombus hollow portion 880b may further comprise a fourth finger-type extension area 878b. For example, the fourth rhombus hollow portion 880b may comprise the fourth longitudinal slit area 872b, the fourth transverse slit area 874b, the fourth cross area 876b and the fourth finger-type extension area 878b. The fourth finger-type extension area 878b may comprise a plurality of separated finger-type electrodes. The fourth cross area 876b, the fifth cross area 876g and the sixth cross area 876r may have the same size and shape. Thus, the blue pixel electrode 806b and the opposite electrode 314 may have a first overlapping area smaller than the second overlapping area of the green pixel electrode 806g and the opposite electrode 314 and the third overlapping area of the red pixel electrode 806r and the opposite electrode 314.

In an embodiment, the fifth and sixth hollow portions 870g, 870r may have a shape different from that of the fourth hollow portion 870b. Alternatively, the fifth and sixth hollow portions 870g, 870r may have different shapes from each other. In other embodiments, the fifth hollow portion 870g may have an area smaller than or equal to that of the sixth hollow portion 870r.

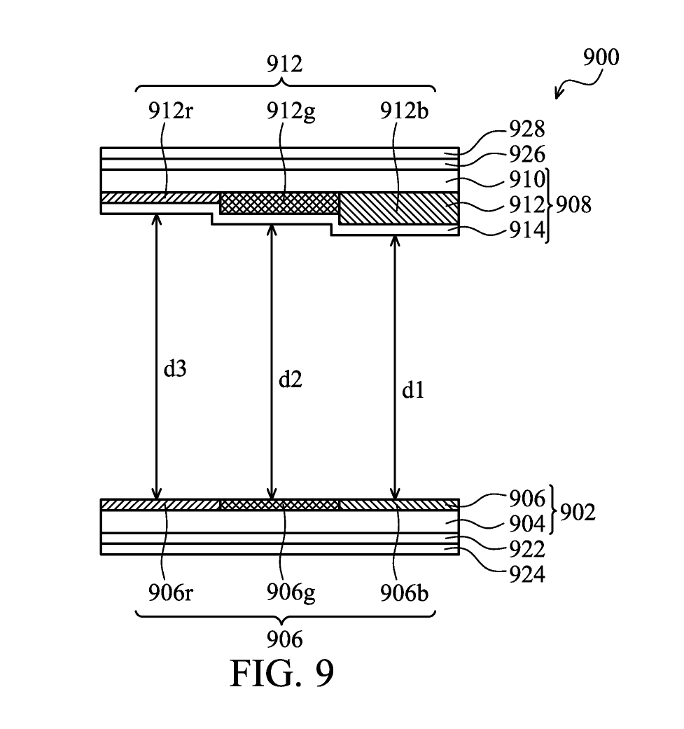

FIG. 9 shows a cross-sectional view of an LCD 900 according to an embodiment of the present disclosure. In an embodiment, the LCD 900 may be a VA type LCD. In some embodiments, the first substrate 902 may be a TFT substrate which comprises a base substrate 902 with at least one first pixel unit 906b, at least one second pixel unit 906g, and at least one pixel electrode 906r disposed thereon. In an embodiment, the first pixel unit 906b, the second pixel unit 906g, and the third pixel unit 906r may be the blue pixel unit 906b, the green pixel unit 906g, and the red pixel unit 906r, respectively. Each pixel unit may have a pixel electrode 906 and a thin-film transistor (not shown) disposed on the base substrate. For example, the first pixel unit 906b, the second pixel unit 906g and the third pixel unit 906r may respectively comprise the first pixel electrode 906b, the second pixel electrode 906g, and the third pixel electrode 906r. The pixel electrode 906 may be formed of any suitable transparent conductive material. A black matrix (not shown) may be disposed between each pixel. In the following sections of the present disclosure, for clarity and understanding, the pixel electrode in the first electrode unit 906b is referred as to the blue pixel electrode 906b, the pixel electrode in the second pixel unit is referred as to the green pixel electrode 906g, and the pixel electrode in the third pixel unit is referred as to the red pixel electrode 906r. However, this is not intended to limit the scope of these pixel electrodes.

The second substrate 908 may be a glass substrate with an opposite electrode 914 and a color filter 912 may be disposed thereon. A liquid-crystal layer (not shown) may be interposed between the first substrate 902 and the second substrate 908, such as between the pixel electrode 906 and the opposite electrode 914. The liquid-crystal layer may comprise a twisted nematic liquid-crystal material, for example, a negative nematic liquid-crystal or a positive nematic liquid crystal. In an embodiment, chiral active substances, such as chiral dopants, may be added to the liquid-crystal layer. Thus, the liquid-crystal molecules of the liquid-crystal layer may twist along an axis, thereby having optical activity, and the axis is parallel to a normal line of the first substrate 902.

The color filter 912 may comprise a blue filter 912b with respect to the blue pixel electrode 906b, a green filter 912g with respect to the green pixel electrode 906g, and a red filter 912r with respect to the red pixel electrode 906r. The blue filter 912b, the green filter 912g and the red filter 912r may have different thicknesses. For example, the blue filter 912b may have a thickness greater than that of the green filter 912g and the red filter 912r. Since the opposite electrode 914 is conformally formed on the color filter 912, the gap d1 between the blue pixel electrode 906b and the opposite electrode 914 may be smaller than the gap d2 between the green pixel electrode 906g and the gap d3 between the red pixel electrode 906r and the opposite electrode 914. Thus, the grey level inversion in the blue pixel unit 906b may be improved. It should be noted that the LCD 900 may also comprise any one of the electrode patterns shown in FIGS. 4-8, for improving the grey level inversion in the blue pixel unit electrode without sacrificing transmittance.

While the preferred embodiments of the invention have been described above, it will be recognized and understood that various modifications can be made to the invention and the appended claims are intended to cover all such modifications which may fall within the spirit and scope of the invention.

What is claimed is:

1. A liquid-crystal display, comprising:
a first substrate having a first pixel electrode, a second pixel electrode and a third pixel electrode;
a second substrate having an opposite electrode, wherein the first pixel electrode has a first overlapping area overlapped with the opposite electrode, the second pixel electrode has a second overlapping area overlapped with the opposite electrode, and the third pixel electrode has a third overlapping area overlapped with the opposite electrode; and
a liquid-crystal layer interposed between the first substrate and the second substrate;
wherein the first overlapping area is smaller than the second overlapping area, and the first overlapping area is smaller than the third overlapping area.

2. The liquid-crystal display according to claim 1, wherein the first pixel electrode comprises a first hollow portion, the second pixel electrode comprises a second hollow portion and the third pixel electrode comprises a third hollow portion, wherein the opposite electrode has a fourth hollow portion with respect to the first hollow portion, a fifth hollow portion with respect to the second hollow portion, and a sixth hollow portion with respect to the third hollow portion.

3. The liquid-crystal display according to claim 2, wherein the area of the first hollow portion is greater than the area of the second hollow portion, and the area of the first hollow portion is greater than the area of the third hollow portion.

4. The liquid-crystal display according to claim 2, wherein the area of the fourth hollow portion is greater than the area of the fifth hollow portion, and the area of the fourth hollow portion is greater than the area of the sixth hollow portion.

5. The liquid-crystal display according to claim 2, wherein the first hollow portion comprises at least one first longitudinal slit area, at least one first transverse slit area, and at least one first cross area located at the intersection of the first longitudinal slit area and the first transverse slit area; the second hollow portion comprises at least one second longitudinal slit area, at least one second transverse slit area, and at least one second cross area located at the intersection of the second longitudinal slit area and the second transverse slit area; the third hollow portion comprises at least one third longitudinal slit area, at least one third transverse slit area and at least one third cross area located at the intersection of the third longitudinal slit area and the third transverse slit area; the fourth hollow portion comprises at least one fourth longitudinal slit area, at least one fourth transverse slit area and at least one fourth cross area located at the intersection of the fourth longitudinal slit area and the fourth transverse slit area; the fifth hollow portion comprises at least one fifth longitudinal slit area, at least one fifth transverse slit area and at least one fifth cross area located at the intersection of the fifth longitudinal slit area and the fifth transverse slit area; and the sixth hollow portion comprises at least one sixth longitudinal slit area, at least one sixth transverse slit area and at least one sixth cross area located at the intersection of the sixth longitudinal slit area and the sixth transverse slit area.

6. The liquid crystal display according to claim 5, wherein the first longitudinal slit area is interleavely arranged with the fourth longitudinal slit area, the first transverse slit area is interleavely arranged with the fourth transverse slit area, and the first cross area is interleavely arranged with the fourth cross area; the second longitudinal slit area is interleavely arranged with the fifth longitudinal slit area, the second transverse slit area is interleavely arranged with the fifth transverse slit area, and the second cross area is interleavely arranged with the fifth cross area; and the third longitudinal slit area is interleavely arranged with the sixth longitudinal slit area, the third transverse slit area is interleavely arranged with the sixth transverse slit area, and the third cross area is interleavely arranged with the sixth cross area.

7. The liquid-crystal display according to claim 6, wherein the first hollow portion further comprises at least one first finger-type extension area extending around from the first longitudinal slit area, the first transverse slit area, and the first cross section such that the first hollow portion comprises at least one first rhombus hollow portion which has a substantially rhombus shape with a center located at the first cross area; the second hollow portion further comprises at least one second finger-type extension area extending around from the second longitudinal slit area, the second transverse slit area and the second cross section such that the second hollow portion comprises at least one second rhombus hollow portion which has a substantially rhombus shape with a center located at the second cross area; and the third hollow portion further comprises at least one third finger-type extension area extending around from the third longitudinal slit area, the third transverse slit area and the third cross section such that the third hollow portion comprises at least one third rhombus hollow portion which has a substantially rhombus shape with a center located at the third cross area, and wherein the first finger-type extension area, the second finger-type extension area and the third finger type extension area further comprise finger-type electrodes.

8. The liquid-crystal display according to claim 7, wherein the distance from a side of the first rhombus hollow portion to its adjacent fourth cross section area is less than the distance from a side of the second rhombus hollow portion to its adjacent fifth cross section area, the distance from a side of the first rhombus hollow portion to its adjacent fourth cross section area is less than and the distance from a side of the third rhombus hollow portion to its adjacent sixth cross section area.

9. The liquid-crystal display according to claim 7, wherein the fourth hollow portion further comprises at least one fourth finger-type extension area extending around from the fourth longitudinal slit area, the fourth transverse slit area, and the fourth cross section such that the fourth hollow portion comprises at least one fourth rhombus hollow portion which has a substantially rhombus shape with a center located at the fourth cross area; the fifth hollow portion further comprises at least one fifth finger-type extension area extending around from the fifth longitudinal slit area, the fifth transverse slit area and the fifth cross section such that the fifth hollow portion comprises at least one fifth rhombus hollow portion which has a substantially rhombus shape with a center located at the fifth cross area; and the sixth hollow portion further comprises at least one sixth finger-type extension area extending around from the sixth longitudinal slit area, the sixth transverse slit area, and the sixth cross section such that the sixth hollow portion comprises at least one sixth rhombus hollow portion which has a substantially rhombus shape with a center located at the sixth cross area, and wherein the fourth finger-type extension area, the fifth finger-type extension area, and the sixth finger type extension area further comprise finger-type electrodes.

10. The liquid-crystal display according to claim 9, wherein the distance from a side of the first rhombus hollow portion to its adjacent fourth cross section area is less than the distance from a side of the second rhombus hollow portion to its adjacent fifth cross section area, the distance from a side of the first rhombus hollow portion to its adjacent fourth cross section area is less than and the distance from a side of the third rhombus hollow portion to its adjacent sixth cross section area.

11. The liquid-crystal display according to claim 10, wherein the area of the first rhombus hollow portion is equal to the area of the second rhombus hollow portion, and the area of the first rhombus hollow portion is equal to the area of the third rhombus hollow portion.

12. The liquid-crystal display according to claim 10, wherein the area of the fourth rhombus hollow portion is equal to the area of the fifth rhombus hollow portion, and the area of the fourth rhombus hollow portion is equal to the area of the fifth rhombus hollow portion the sixth rhombus hollow portion.

13. The liquid-crystal display according to claim 1, wherein the liquid-crystal layer comprises a chiral dopant doped therein.

14. The liquid-crystal display according to claim 1, wherein the second overlapping area is smaller than the third overlapping area.

15. The liquid-crystal display according to claim 1, wherein the first pixel electrode locates at a blue pixel unit, the second pixel electrode locates at a green pixel unit, and the third pixel electrode locates at a red pixel unit.

16. The liquid-crystal display according to claim 1, wherein the gap between the first pixel electrode and the second substrate is smaller than the gap between the second pixel electrode and the second substrate, and the gap between the second pixel electrode and the second substrate is smaller than the gap between the third pixel electrode and the second substrate.

17. A vertical alignment liquid-crystal, comprising:
a first substrate having a first pixel electrode, a second pixel electrode and a third pixel electrode;
a second substrate having an opposite electrode; and
a liquid-crystal layer interposed between the first substrate and the second substrate, wherein the liquid-crystal layer comprises a chiral dopant doped therein;
wherein the gap between the first pixel electrode and the second substrate is smaller than the gap between the second pixel electrode and the second substrate, and the gap between the first pixel electrode and the second substrate is smaller than the gap between the third pixel electrode and the second substrate.

18. The vertical alignment liquid-crystal according to claim 17, wherein the second substrate further comprises a color filter which comprises a blue filter with respect to the first pixel electrode, a green filter with respect to the second pixel electrode and a red filter with respect to the third pixel electrode, and wherein the blue filter has a thickness greater than that of the green filter and the red filter.

19. The vertical alignment liquid-crystal according to claim 17, wherein the gap between the second pixel electrode and the second substrate is smaller than the gap between the third pixel electrode and the second substrate.
